(19) United States
(12) Patent Application Publication
(10) Pub. No.: US 2024/0270930 A1
(43) Pub. Date: Aug. 15, 2024

(54) THERMALLY CONDUCTIVE COMPOSITION

(71) Applicant: HENKEL IP & HOLDING GMBH, Duesseldorf (DE)

(72) Inventors: Kevin White, Chaska, MN (US); Yuqiang Qian, Falcon Heights, MN (US)

(21) Appl. No.: 18/567,068

(22) PCT Filed: Jun. 7, 2022
(86) PCT No.: PCT/US2022/032430

§ 371 Date: Dec. 5, 2023

Related U.S. Application Data
(60) Provisional application No. 63/208,117, filed on Jun. 8, 2021.

(51) Int. Cl. C08K 3/22; C08G 65/336; C08L 101/10

(52) U.S. Cl. CPC C08K 3/22; C08G 65/336; C08L 101/10; C08K 2003/2227; C08K 2201/001; C08K 2201/005; C08K 2201/006; C08L 2203/20

(57) ABSTRACT

A thermally conductive composition includes a polymer formed from a condensation-curable silyl-modified resin and particulate alumina filler having a high total specific surface area. The composition exhibits a thermal conductivity of at least 1 W/m*K. and is curable without added environmental moisture and with reduced catalyst loading.

### FIELD OF THE INVENTION

The present invention relates to thermally conductive materials generally, and more particularly to thermal interface materials based on polymers that are dispensable from two-component systems and curable in a low-moisture environment and with reduced catalyst dependency.

### BACKGROUND OF THE INVENTION

Thermally conductive materials are widely employed as interfaces between, for example, a heat-generating electronic component and a heat dissipater for permitting transfer of excess thermal energy from the electronic component to a thermally coupled heat dissipater. Numerous designs and materials for such thermal interfaces have been implemented, with the highest performance being achieved when gaps between the thermal interface and the respective heat transfer surfaces are substantially avoided to promote conductive heat transfer from the electronic component to the heat dissipater. The thermal interface materials therefore preferably mechanically conform to the somewhat uneven heat transfer surfaces of the respective components. Important physical characteristic of high performance thermal interface materials are therefore flexibility and low hardness. In the case of dispensable materials, it is additionally important that the thermal interface is capable of wetting the heat transfer surface, and that it provides suitable adhesive and cohesive strength to avoid delamination and to maintain the form and function of the interface over the anticipated working lifetime. Dispensable thermal interface materials therefore may be designed with a yield stress to avoid significant spreading after dispensation, or without a yield stress to maximally flow and penetrate surfaces. Curing behavior of the material may also be tailored to both avoid particle settling and to provide sufficient pre-cure time for re-work and handling.

Some example conformable thermally conductive compositions include silicone polymers forming a matrix that is filled with thermally conductive particles such as alumina (aluminum oxide) and boron nitride. The coatings are typically sufficiently flexible to conform to irregularities of the interface surfaces, whether at room temperature and/or elevated temperatures. However, silicone-based coatings are often not suitable for many applications due to the presence of low molecular weight volatile components that may contaminate surfaces and are difficult to remove. Alternative non-silicone polymer systems have limitations in their temperature stability and glass transition behavior. Some conventional non-silicone systems that exhibit acceptable hardness values also exhibit relatively high pre-cure viscosities that present challenges for dispensing and assembly. Other non-silicone systems may have suitable pre-cure viscosities for dispensing and assembly as well as acceptable post-cure hardness, but typically require either a reactive diluent that can interfere with the polymer cross-linking reaction, or non-reactive diluents that tend to migrate out of the coating over time. Silyl-modified polymers represent a class of materials that have been considered for dispensable non-silicone applications.

The development of thermally conductive coatings based on silyl-modified polymers is promising for their desirable mechanical properties like low hardness, high use temperature, and versatility. However, it has proven challenging to effectively cure silyl-modified polymers due to their low reactivity and multi-step reaction chemistry. These challenges are exacerbated in closed applications, such as battery cells, where the material is not exposed to atmospheric moisture to aid in the typical hydrolysis-condensation cure pathway.

Silyl-modified polymers such as polyether or polyurea containing one or more terminal alkoxysilane functional groups are widely used in applications where the curable resin is exposed to atmospheric moisture, which is required to achieve the initial hydrolysis of functional end groups and enable the subsequent condensation reaction. In the presence of moisture alone, the reaction proceeds at a slow rate. Aggressive catalysts are typically required to obtain suitable cure rates. These catalysts are usually based on organo-metal catalyst compounds, which are known to have health and environmental hazards. Although organo-metal free systems have been proposed, they have been found to lack the necessary activity to promote an effective polymerization reaction. Conventional silyl-modified polymer systems accordingly require the presence of moisture and the use of catalysts that in some cases may have environmental toxicity.

Use of condensation curable polymers such as silyl-modified polymers in closed geometries presents particular challenges due to the unavailability of atmospheric moisture to initiate the hydrolysis portion of the cure reaction. One approach can utilize a two-component system in which water is added to the non-resin component prior to mixing. However, there are environmental limitations on the maximum amount of catalyst that can be used in such a system, and a two-component system is limited to half the catalyst content as in an equivalent one-component system. Moreover, increasing the amount of water in the formulation can introduce problems associated with an incompatibility with hydrophobic plasticizers that are often included in coating compositions. The incompatibility can lead to outgassing at elevated temperatures, which can leave voids, promote bleed, and otherwise limit the lifetime of the product. Various silanes are available that can be used to potentially accelerate curing, but these tend to have little practical impact and do not assist with the hydrolysis portion of the reaction.

It is therefore an undertaking of the present invention to provide a thermally conductive material that is curable in low moisture environments without increasing the amount of catalyst, diminishing the shelf life or stability of the cured composition, or significantly altering the flow behavior and other functional properties of the formulation.

It is another undertaking of the present invention to provide a thermally conductive composition that is formed from a two-part reactant composition deliverable through conventional dispensation equipment, and curable in low moisture environments.

It is a further undertaking of the present invention to provide a thermally conductive composition formed from condensation-curable resin that exhibits a high thermal conductivity while being dispensable at high rates.

### SUMMARY OF THE INVENTION

By means of the present invention, a low-hardness, high thermal conductivity material may be formed from a composition exhibiting a viscosity suitable for dispensation as a liquid coating through conventional liquid dispensing equipment. The curable composition may be cured at accelerated rates without increased catalyst content and without significant environmental moisture. For the purposes hereof, the term “significant” is intended to mean more than a trace or residual amount. The curable composition may employ environmentally compatible catalysts that reduce or eliminate dependency on organo-metal catalyst compounds to drive hydrolysis-condensation cure reactions. The curable composition may also employ polymers that are not generally favored due to relatively slow curing kinetics.

The composition generally includes two primary components: a condensation-curable silyl-modified resin and a thermally conductive particulate filler. The pre-cured material exhibits a liquid dispensable viscosity and is curable to form a soft solid with high thermal conductivity. High specific surface area alumina has been discovered to act as a cure accelerator in the compositions of the present invention and has dual use as a thermally conductive filler. The high specific surface area alumina is preferably unmodified.

In one embodiment, a composition includes a polymer formed from a silyl-modified resin, and a particulate filler having a total specific surface area of at least 1 m²/g, wherein a portion of the particulate filler is alumina having a mean particle size of less than 1 μm, and the portion comprising between 0.1-10 wt. % of the composition. The composition further includes less than 0.1 wt. % organo-metal catalyst compound and less than 0.5 wt. % water. The composition exhibits a thermal conductivity of at least 1 W/m*K.

The composition may exhibit a cured hardness of between 20 Shore 00 and 80 Shore A at 25° C.

The surface of the particulate alumina filler may be unmodified. At least a portion of the particulate alumina filler may be fumed alumina. At least a portion of the particulate alumina filler may exhibit predominantly alpha or gamma crystal structure, or a mixture thereof.

The total specific surface area of the particulate filler may be between 4-150 m²/g.

The composition may include 1-5 wt. % of the polymer and 50-95 wt. % of the particulate filler. The composition may include 0.1-1 wt. % of the portion of the particulate alumina filler having a mean particle size of less than 1 μm. The composition may include 5-10 wt. % of a plasticizer having a viscosity of less than 100 cP at 25° C.

A thermal interface material includes 1-5 wt. % of a polymer formed from a silyl-modified resin, and 50-95 wt. % of thermally conductive particulate filler having a particle size distribution with a first portion of the particle size distribution comprising 0.1-10 wt. % of the thermal interface material. The first portion of the particle size distribution is alumina particles having a mean particle size of between 5-1000 nm and a specific surface area of 4-150 m²/g. The thermal interface material exhibits a thermal conductivity of at least 1 W/m*K, and a hardness of between 20-80 Shore 00 at 25° C.

The thermally conductive particulate filler may have a total specific surface area of at least 1 m²/g.

The first portion of the particle size distribution may have a mean particle size of between 5-250 nm.

The particulate alumina filler may have an unmodified surface.

A battery system includes a battery and the thermal interface material thermally coupled to the battery. The battery system may further include a heat dissipater thermally coupled to the thermal interface material.

A two-part curable composition includes a first part with particulate filler having a particle size distribution, wherein a first portion of the particle size distribution is alumina comprising 0.1-10 wt. % of the first part, a mean particle size of between 5-1000 nm, and a specific surface area of 4-150 m²/g. A second portion of the particle size distribution comprises 80-95 wt. % of the first part and has a mean particle size of between 1-100 μm. A second part of the two-part curable composition includes a condensation-curable silyl-modified resin, wherein the resin is curable with exposure to the first part to a cured material exhibiting a hardness of between 20 Shore 00 and 80 Shore A at 25° C.

The two-part curable composition may be curable to a gelled condition within 24 hours at 25° C.

The two-part curable composition may include a silane terminated polyether.

The two-part curable composition may include less than 0.1 wt. % organo-metal catalyst compound and less than 0.5 wt. % water.

The second part of the two-part curable composition may include 80-95 wt. % of thermally conductive particulates selected from alumina, aluminum trihydrate, aluminum nitride, aluminum hydroxide, graphite, zinc oxide, magnesium oxide, silicon carbide, boron nitride, metal particles, and combinations thereof.

The two-part curable composition may exhibit a thermal conductivity of at least 1 W/m*K.

The cured material from the two-part curable composition includes particulate alumina having a total specific surface area of at least 1 m²/g.

The two-part curable composition may include any combination of some or all of the above features and may exclude one or more of the above features.

### BRIEF DESCRIPTION OF THE DRAWINGS

FIG. 1 is a chart illustrating cured hardness as a function of total specific surface area of particulate alumina filler.

### DETAILED DESCRIPTION OF THE PREFERRED EMBODIMENTS

The objects and advantages enumerated above together with other objects, features, and advances represented by the present invention will now be presented in terms of detailed embodiments. Other embodiments and aspects of the invention, however, are recognized as being within the grasp of those having ordinary skill in the art.

The thermally conductive composition of the present invention may be formed as a coating on a surface or a self-supporting body for placement along a thermal dissipation pathway, typically to remove excess heat from a heat-generating electronic component. The thermally conductive composition exhibits a desired thermal conductivity of at least 1 W/m*K, and sufficient wettability to fully coat the surface prior to curing. The composition preferably exhibits sufficient flexibility and cohesive strength to provide a stable interface. The composition preferably cures to a gel condition within 24 hours, within which the storage modulus exceeds the loss modulus, as measured by a rheometer as known in the art.

The thermally conductive material is formed from a two-part curable composition that is dispensable from at least two separate containers in order to separate the reactive silyl-modified resin from a reaction catalyst and water until such time that the material is desired to be cured. The present composition is mixed, dispensed and cured in situ through silyl hydrolyzation and condensation with the reaction products having an irreversible soft, solid form. In many applications, the hydrolysis pathway proceeds due to absorption of environmental moisture. Insufficient environmental moisture can slow the hydrolyzation reaction, or even prevent its completion altogether. Increasing the water content in the two-part composition can make water available for the hydrolyzation reaction, but this is not desired due to incompatibilities with hydrophobic plasticizers and the reactive resin. The present composition overcomes the challenge of insufficient environmental moisture through the use of high surface area alumina as a cure accelerator.

One or both parts of the two-part curable composition may additionally contain thermally conductive fillers, including alumina, as well as rheology modifiers, compatibilizers, plasticizers, pigments, water scavengers, anti-oxidants, and other functional fillers.

The disclosed curable compositions when mixed and ready to use can have a low shear rate viscosity below 1,500,000 cP. In some applications the disclosed curable compositions when mixed can have a viscosity below 750,000 cP. In some applications the disclosed curable compositions when mixed can have a viscosity in the range of about 200,000 cP to about 500,000 cP. Low shear rate viscosity can be measured at 25° C. and a shear rate of 1 1/s using a parallel plate rheometer with 25 mm parallel plates.

In one embodiment the composition is thixotropic and will show a viscosity decrease at higher flow rates. These compositions will have a viscosity as low as 5,000 cP for high volume dispensing applications and up to 50,000 cP for other applications. High shear rate viscosity can be measured at 30° ° C. and a shear rate of 3,000 1/s using a capillary rheometer typically according to ISO 11443. The disclosed curable compositions when mixed will have an extrusion rate suitable for use in that application taking into account the extrusion pressure, nozzle type, etc. Extrusion rate can found by measuring the amount of each component separately extruded through a Nordson EFD syringe barrel with no added nozzle at 90 psi. Each component should have an extrusion rate of greater than 50 g/minute, preferably greater than 150 g/minute and in some cases greater than 300 g/minute.

### Resin

A variety of silyl-modified resins may be employed in the matrices of the present invention. Condensation-curable silane-terminated resins participate in a hydrolysis-condensation cure pathway, preferably at and above ambient temperatures. In some embodiments, the resins may be non-silicone, wherein no more than a trace amount of silicone is contained in the composition. In some embodiments, no silicone is contained in the composition. In some embodiments the non-silicone resins are substantially free of —Si—O— units therein. In other embodiments the non-silicone resins exclude silicone and polysiloxane resins and have no —Si—O— units therein.

Silyl-modified reactive resins employed herein are present in the range of about 1 up to about 50 percent by weight of the total composition; in some embodiments, the compositions comprise in the range of about 1 up to about 20 percent by weight of silyl-modified reactive resin; in some embodiments, the compositions comprise in the range of about 1 up to about 10 percent by weight of silyl-modified reactive resin; in some embodiments, the compositions comprise in the range of 1 to 7 percent by weight of silyl-modified reactive resin.

Example resins suitable for the reactive resins of the present invention include reactive polymer resins with at least one silyl-reactive functional group, including at least one bond that may be activated with water. Example silyl-reactive functional groups include alkoxy silane, acetoxy silane, and ketoxime silane.

The reactive polymer resin can be any reactive polymer capable of participating in a silyl hydrolyzation reaction. For example, the reactive polymer resin can be selected from a wide range of polymers as polymer systems that possess reactive silyl groups, for example a silyl-modified reactive polymer. The silyl-modified reactive polymers can have a non-silicone backbone to limit or avoid the release of silicone when heated, such as when used in an electronic device. Preferably, the silyl-modified reactive polymer has a non-silicone backbone. Preferably, the silyl-modified reactive polymer has a flexible backbone for lower modulus and glass transition temperature. Preferably, the silyl-modified reactive polymer has a flexible backbone of polyether, polyester, polyurethane, polysiloxane, polyacrylate, polyisoprene, polybutadiene, polystyrene-butadiene, or polybutylene-isoprene.

The silyl-modified reactive polymer can be obtained by reacting a polymer with at least one ethylenically unsaturated silane in the presence of a radical starter, the ethylenically unsaturated silane carrying at least one hydrolyzable group on the silicon atom. For example, the silyl modified reactive polymer can be dimethoxysilane modified polymer, trimethoxysilane modified polymer, or triethoxysilane modified polymer. For example, the silyl modified reactive polymer may include a silane modified polyether, polyester, polyurethane, polyacrylate, polyisoprene, polybutadiene, polystyrene-butadiene, or polybutylene-isoprene.

The ethylenically unsaturated silane may be selected from the group made up of vinyltrimethoxysilane, vinyltriethoxysilane, vinyldimethoxymethylsilane, vinyldiethoxymethylsilane, trans-ß-methylacrylic acid trimethoxysilylmethyl ester, and trans-ß-methylacrylic acid trimethoxysilylpropyl ester.

The silyl-modified reactive polymer preferably comprise(s) silyl groups having at least one hydrolyzable group on the silicon atom in a statistical distribution. For example, in one embodiment the silyl-modified reactive polymer can be a silane-modified polymer of general formula:

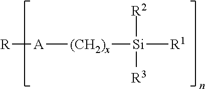

in which; R is a mono- to tetravalent polymer radical, R¹·R²·R³ independently is an alkyl or alkoxy group having 1 to 8 C atoms and A represents a carboxy, carbamate, amide, carbonate, ureido, urethane or sulfonate group, oxygen atom or covalent bond, x=1 to 8 and n=1 to 4. In some embodiments R is free of —Si—O— units.

The silyl-modified reactive polymer can also be obtained by reacting a polymer with hydroxy group and alkoxysilane with isocyanate group. For example, the silyl modified reactive polymer can be dimethoxysilane modified polyurethane polymer, trimethoxysilane modified polyurethane polymer, or triethoxysilane modified polyurethane polymer. Further, the silyl-modified reactive polymer can be a α-ethoxysilane modified polymer of the average general formula:

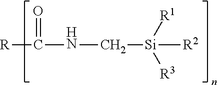

in which R is a mono- to tetravalent polymer residue, at most one third of the polymer of formula contained residues R¹. R² and R³ are independently alkyl radicals having 1 to 4 carbon atoms, at least one-quarter of the polymer of the formula residues contained R¹, R², and R³ are independently ethoxy residues that any remaining radicals R¹, R², and R³ independently of one another are methoxy radicals, and wherein n=1 to 4. In some embodiments R is free of —Si—O— units.

Silyl-modified reactive polymers are available, for example, as dimethoxysilane modified MS polymer with polyether backbone and XMAP™ polymer with polyacrylate backbone from Kaneka Belgium NV, trimethoxysilane modified ST polymer from Evonik, triethoxysilane modified Tegopac™ polymer from Evonik, silane modified Desmoseal™ polymer from Covestro, or di- or tri-methoxy silane modified Geniosil™ polymer from Wacker.

### Alumina Cure Accelerator

Applicants have discovered that relatively high surface area alumina, and preferably alumina without surface modification, accelerates the cure of silyl-modified reactive resins such as silane-terminated resins. The cure acceleration scales with total surface area of the filler. However, for the dispensable compositions of the present invention, a balance must be struck between cure acceleration and viscosity/dispensability, since excessive alumina loading can detrimentally affect dispensability. It has been found that a loading range of the alumina in combination with a total surface area of the alumina may achieve the most preferred performance in accelerating cure of silane-terminated reactive resins.

Alumina useful as a cure accelerator is preferably high specific surface area particulate having an unmodified surface. For the purposes hereof, the term “unmodified” or “unmodified surface” means that the alumina particle has not been chemically, physically, or electrically modified by an applied treatment process. Changes to the alumina particle as a result of exposure to ambient environment are not considered to be an applied treatment process. An example unmodified alumina is fumed alumina. In some embodiments, the particulate alumina may be surface modified. An example surface modification of the particulate alumina may be for hydrophobicity, such as silane treatment.

It has been found that certain surface crystallinity of the alumina particles may promote the cure acceleration property. In particular, alumina with one or both of alpha and gamma crystallinity exhibited desired results for accelerating the cure of silyl-modified reactive resins.

It has also been found that alumina particle size has an important role in facilitating the cure acceleration. In some embodiments, the alumina particles have an average particle size (d₅₀) in the range of between 5 nm to 100 μm. In some embodiments, the average alumina particle size is in the range of 5 nm to 20 μm. In some embodiments, the average alumina particle size is in the range of 5 nm to 1000 nm. In some embodiments, the average alumina particle size is in the range of between 5 nm to 250 nm. The alumina particles may be of any suitable shape, such as spherical, rod-like, plate-like, or branched particles, and one or more particle shapes may be employed in compositions of the present invention.

In a useful embodiment, the particulate alumina filler comprises a portion of the thermally conductive filler in the composition. In some embodiments, a first portion of the thermally conductive filler is particulate alumina filler having an average particle size of less than 1 μm. In some embodiments, the particulate alumina filler of the first portion has an average particle size of between 5 nm to 500 nm. In some embodiments, the particulate alumina filler of the first portion has an average particle size of between 5 nm to 250 nm. In some embodiments, the particulate alumina filler of the first portion has an average particle size of between 5 nm to 100 nm. The first portion of the thermally conductive filler preferably comprises between 0.1-10 wt. % of the total composition. In some embodiments, the first portion of the thermally conductive filler preferably comprises between 0.1-1 wt. % of the total composition.

A second portion of the thermally conductive filler may have an average particle size of greater than 1 μm. In some embodiments, the second portion of the thermally filler has an average particle size of between 1 μm to 100 μm. In some embodiments, the second portion of the thermally conductive filler has an average particle size of between 1 μm to 60 μm. The second portion of the thermally conductive filler preferably comprises between 20-95 wt. % of the total composition. In some embodiments, the second portion of the thermally conductive filler preferably comprises between 40-95 wt. % of the total composition. In some embodiments, the second portion of the thermally conductive filler preferably comprises between 50-95 wt. % of the total composition.

The thermally conductive filler preferably comprises between 50-95 wt. % of the total composition. Loading of the particulate alumina portion of the thermally conductive filler is preferably within a range that does not unduly inhibit dispensability of the uncured two-part composition, nor unduly limits flexibility of the cured composition. Therefore, a balance between the properties of cure acceleration and viscosity/hardness effect is preferably struck in the loading ranges and particle size ranges of the particulate alumina filler. In some embodiments, the particulate alumina filler is present in the total composition at between 1-1000 phr. In some embodiments, the particulate alumina filler is present in the total composition at between 1-100 phr. In some embodiments, the particulate alumina filler is present in the total composition at between 1-50 phr.

It has been found that the specific surface area (total surface area of a material per unit of mass, “SSA”) of the particulate alumina filler in the compositions of the present invention contributes to the cure acceleration property. For the purposes hereof, the term “total specific surface area” means the specific surface area of the total alumina filler in the composition. In some embodiments the total specific surface area of the particulate alumina filler is at least 0.2 m²/g. In some embodiments, the total specific surface area of the particulate alumina filler is at least 1 m²/g. In some embodiments, the total specific surface area of the particulate alumina filler is between 1-200 m²/g. In some embodiments, the total specific surface area of the particulate alumina filler is between 4-150 m²/g.

In some embodiments of the invention, thermally conductive particles in addition to the particulate alumina filler may be included to enhance thermal conductivity of the composition. The particles may be both thermally and electrically conductive. Alternatively, the particles may be thermally conductive and electrically insulating. Example thermally conductive particles include aluminum trihydrate, zinc oxide, graphite, magnesium oxide, silicon carbide, aluminum nitride, boron nitride, metal particulate, and combinations thereof. The thermally conductive particles may be of various shape and size, and it is contemplated that a particle size distribution may be employed to fit the parameters of any particular application.

It is desirable that the compositions of the present invention exhibit a thermal conductivity of at least 1 W/m*K, and more preferably at least 2 W/m*K.

### Plasticizer

The present compositions may include a plasticizer to adjust the viscosity of the dispensable mass, particularly under shear, and to maintain a flexibility/softness property when the composition is in a cured state. The cured compositions exhibit a relatively low modulus or hardness of less than 80 Shore A to mitigate the stress in electronic component assembly and to promote conformability of the thermal material to respective contact surfaces of the electronic component.

Plasticizers useful in the present compositions are those which are effective in facilitating fluency of the coherent mass making up the composition. The plasticizers of the present invention may preferably be low-volatility liquids that reduce the viscosity of the overall pre-cured composition so that the composition is readably dispensable through liquid dispensing equipment. The plasticizer may therefore exhibit a viscosity of less than 1000 cP at 25° C. In another embodiment, the plasticizer may exhibit a viscosity of less than 500 cP at 25° C. In a further embodiment, the plasticizer may exhibit a viscosity of less than 100 cP at 25° C. Preferably, the plasticizer exhibits a viscosity of between 1-50 cP at 25° C.

The plasticizer is preferably added to the composition in an amount suitable to appropriately adjust viscosity for pre-cured dispensability, and post-cured softness. In some embodiments, the plasticizer may represent about 1-50 percent by weight of the composition. In some embodiments, the plasticizer may represent about 1-20 percent by weight of the composition. In some embodiments, the plasticizer may represent about 5-10 percent by weight of the composition. The plasticizer may preferably be present at less than 20% by weight of the composition.

Example plasticizers include sebacates, adipates, terephthalates, dibenzoates, gluterates, phthalates, azelates, benzoates, sulfonamides, organophosphates, glycols, polyethers, trimellitates, polybutadienes, epoxies, amines, acrylates, thiols, polyols, and isocyanates.

The silyl-modified reactive polymer forming the bulk matrix of the composition preferably forms a network without reacting with the plasticizer. The applicant has found that silyl-modified polymers (SMP), such as those described in U.S. Pat. No. 3,632,557 and U.S. Patent Application Publication No. 2004/0127631, the contents of which being incorporated herein in their entireties, may be particularly useful in the preparation of thermally conductive materials of the present invention.

### Rheology Modifiers

Certain rheological modifiers, sometimes referred to as “thickeners”, may be included in the compositions of the present invention to aid in the flow characteristics, thixotropy, and dispensed form stability. The rheological modifiers useful in the present invention may include thickening agents such as fumed silica, organoclay, polyurethanes, and acrylic polymers. The rheological modifiers may also include dispersion agents for the thermally conductive fillers. In some embodiments, the rheological modifiers may themselves contribute to the thermal conductivity and/or curing of the composition. The rheological modifiers may inhibit settling of fillers during storage.

Thickening agents used in the compositions of the present invention are present in the range of about 0 up to about 3 percent by weight. In some embodiments, the compositions comprise in the range of about 0.01 up to about 1 percent by weight thickening agent. In some embodiments, the compositions comprise in the range of about 0.05 up to about 0.5 percent by weight thickening agent. In some embodiments, the compositions comprise less than 0.5 percent by weight thickening agent.

### Reaction Catalyst

A reaction catalyst may be employed to further facilitate the hydrolyzation-condensation cure reaction of the silyl-modified reactive resin. Example reaction catalysts useful in the compositions of the present invention include organotin and organo-zinc and organo-titanium compounds (together referred to herein as “organo-metal catalyst”) that facilitate moisture cure of the silyl-modified reactive resins.

As a result of the discovered cure acceleration property of the particulate alumina, the compositions of the invention are preferably less dependent upon a reaction catalyst. In some embodiments, the use of organo-metal catalyst compounds may be avoided altogether. This may be preferable given the environmental and health toxicity of such compounds. In other embodiments, use of the organo-metal catalyst compounds may be reduced. Moreover, alternative and safer reaction catalysts that are otherwise unsuitable for facilitating moisture cure reactions of silyl-modified resins may be employed in place of at least a portion of the organo-metal catalyst compounds.

Reaction catalysts used in the compositions of the present invention may be present in the range of 0 up to 0.1 percent by weight. In some embodiments, the compositions comprise in the range of 0.01 up to 0.5 percent by weight reaction catalyst. In some embodiments, the compositions comprise in the range of 0.01 up to 0.02 percent by weight reaction catalyst. For the purposes hereof, a concentration of “less than” a specified amount may include 0.

The thermally conductive compositions of the present invention are preferably curable in the presence of water (moisture curable) at ambient temperature. Depending upon the application, the moisture may be available from the ambient environment or from water released from the object(s) to which the composition is applied. The compositions of the invention significantly decrease the amount of water necessary to facilitate the hydrolyzation-condensation cure reaction of the silyl-modified resin. Preferably, the compositions of the invention are curable without addition of environmental moisture. In some embodiments, water may be included as an ingredient in a non-resin part of the multiple part curable composition, for mixture with the reactive resin in situ. Preferably, however, the amount of water required in the composition itself is minor so as not to interfere with functional properties of the thermal material. In some embodiments, water is present in the compositions of the invention in the range of 0 up to 0.5 wt. %. In some embodiments, the compositions comprise in the range of 0.01 up to 0.3 wt. % water. In some embodiments, the compositions comprise in the range of 0.01 up to 0.2 wt. % water.

For the purposes hereof, the term “ambient temperature” is intended to mean the temperature of the environment within which the reaction occurs, and within a temperature range of 15-30° C., and preferably 25° C. The thermally conductive compositions are curable at ambient temperature within 72 hours, and preferably within 24 hours. The thermally conductive compositions may also be curable at elevated temperatures. For the purposes hereof, the term “curable” is intended to mean the composition can react under appropriate conditions and the reaction products will have an irreversible solid form.

### Water Scavenger

The compositions of the present invention preferably include a water scavenger to avoid reaction of the resin-containing component prior to dispensing so as to extend shelf life. The water scavenger may be, for example, alkyltrimethoxysilane, oxazolidines, zeolite powder, p-toluenesulfonyl isocyanate, oxocalcium, and ethyl orthoformate. The water scavenger is preferably vinyltrimethoxysilane. If too much of the water scavenger is included in the composition the curing will be slowed. The water scavenger may be present in an amount of greater than about 0.05 wt. % and less than about 0.5 wt. %, for example about 0.1 wt. % of the composition.

### Optional Additives

In accordance with some embodiments of the present invention, the compositions described herein may further comprise one or more additives selected from fillers, stabilizers, adhesion promoters, solvent, pigments, wetting agents, dispersants, flame retardants, extenders, and corrosion inhibitors. In some embodiments the composition can be free of any or all of the additives.

### EXAMPLES

The Examples described herein are two-component curable compositions using alkoxysilane modified polyether resin as the reactive polymer component.

### Example 1

Example 1 is a 2-component thermally conductive material, including a Part A that contains the organotin catalyst and Part B with the silyl-modified reactive resin. The composition is summarized in Table 1. Part A contained 8 wt. % of a plasticizer with viscosity below 100 cP, 3 wt. % thickening agents (fumed silica, organo clay, and liquid rheology additive), 0.1 wt. % of an organotin catalyst, 0.2% pigment, 0.4 wt. % water, and 88% thermally conductive filler. The standard Part B contained 4 wt. % of a plasticizer with viscosity below 100 cP, 4 wt. % of an alkoxysilane modified polyether resin with dimethoxysilane terminal groups, 1 wt. % thickening agents (fumed silica, organo clay, liquid rheology additives), 0.2 wt. % of resin additives (water scavenger and anti-oxidant), and 90 wt. % of thermally conductive additives. The fillers were dried either by mixing at elevated temperature and vacuum, or at ambient temperature optionally with water scavenger prior to adding the reactive resin to avoid hydrolysis.

TABLE 1

| | Part A | Part B |
|---|---|---|
| Component | (wt. %) | (wt. %) |
| Plasticizer | 8 | 4 |
| Thickening Agent | 3 | 1 |
| Organotin Catalyst | <0.1 | |
| Pigment | <0.2 | 0 |
| Alumina 1 | 56 | 55 |
| Alumina 2 | 32 | 35 |
| Water | 0.4 | 0 |
| Reactive Resin | — | 4 |
| Resin Additives | — | <0.2 |

The formulations were initially prepared with a planetary mixer. The Part A was subsequently modified, as listed in Table 2, using various strategies to modify the curing reaction. The same Part B was used for each test. The separate parts were loaded in 2-component cartridges and mixed during dispensing with a static mixer. Samples were dispensed into small aluminum trays and the hardness evaluated after different time intervals in a controlled environment with temperature of 74° F. and relative humidity of 50%. The hardness was measured with a Shore 00 or Shore A durometer.

TABLE 2

| ID | Shore 00 | Change from Base Part A |
|---|---|---|
| A-1 | 0 | Base formulation |
| A-2 | 40 | Increased catalyst loading 3x |
| A-3 | 0 | Added second organotin catalyst |
| A-4 | 10 | Increased water content from 0.3 to 0.8% |
| A-5 | 35 | +2.5 wt. % Alumina 3 |
| A-6 | 50 | +5% Alumina 3 |
| A-7 | 45 | +5% Alumina 4 |
| A-8 | 25 | +5% Alumina 5 |

The evolution in the Shore 00 hardness for selected formulations is listed in Table 3. In an open tray exposed to air, the base formulation, which contained the maximum permissible level of organotin catalyst to avoid labeling for hazardous classification and 0.4 wt. % water to accelerate the initial hydrolysis step of the curing reaction, required more than 24 hours at room temperature to develop a measurable hardness of the Shore 00 scale and did not reach a plateau in hardness for 7 days. In a closed vessel the material did not cure after 1 week and showed various surface flaws associated with delamination and cracking due to the slow development in mechanical strength, which are not acceptable for many applications.

TABLE 3

| | Storage Time (days) | | | | |
|---|---|---|---|---|---|
| ID | 1 | 3 | 5 | 7 | 10 |
| A-1 | <5 | 45-40 | 45-50 | 53-57 | 55 |
| A-2 | 38 | 40-45 | 35-40 | 35-40 | 40-45 |
| A-3 | 0 | <5 | <5 | 5-10 | 15 |
| A-4 | 10 | 35-40 | 45 | 55 | 55 |
| A-5 | 35-45 | 55 | 55 | 55 | 55 |
| A-6 | 45-50 | 55-60 | 60 | 60 | 60 |
| A-7 | 40-45 | 50-55 | 55 | 55 | 55 |
| A-8 | 25-30 | 50 | 55 | 55 | 55 |

Increasing the amount of organotin catalyst to 3× the acceptable loading promoted a faster cure but lowered the final hardness and strength (Test A-2). This change indicates a change in the backbone structure that is not desirable. Other trials based on changing the type of organotin catalyst, adding a secondary catalyst (Test A-3), and increasing the amount of water (Test A-4) similarly showed insufficient improvements in curing rate within the acceptable range for applications.

The most significant improvements were observed with the addition of untreated alumina filler. Three types of small diameter spherical alumina were used and each showed>50% cure after 24 hours. At a given loading, the rate scaled with the specific surface area (SSA) of the filler and increasing the loading further enhanced the reaction rate, which support that interactions at the alumina surface were driving the reaction. Importantly, the final hardness of the material was not significantly altered by the addition of the untreated alumina, as observed with the catalyst changes, and there is no change in volatile content such as with water. The high thermal conductivity of the alumina also allows for partial replacement of the treated alumina to compensate for changes in viscosity and dispense rate without altering the thermal performance of the material.

TABLE 4

| | | Diameter | SSA |
|---|---|---|---|
| Material | Treatment | [μm] | [m2/g] |
| Alumina 1 | None | 40-60 | 0.2 |
| Alumina 2 | Silane | 2-5 | 4 |
| Alumina 3 | None | <1 | 10 |
| Alumina 4 | None | <1 | 8 |
| Alumina 5 | None | 2-3 | 4 |

### Example 2

For Example 2, the amount of organotin catalyst was increased to accelerate the cure to an acceptable level. A description of the 2-part formulation is provided in Table 5. The dimethoxysilane-terminated reactive resin was included in Part B at 4 wt. % and Part A contained 0.4 wt. % water.

TABLE 5

| | Part A | Part B |
|---|---|---|
| Component | (wt. %) | (wt. %) |
| Plasticizer | 9 | 4 |
| Rheology Modifier | 0.3 | 0.3 |
| Organotin Catalyst | 0.1-0.5 | — |
| Pigment | 0.2 | — |
| Alumina 1 | 58 | 56 |
| Alumina 2 | 33 | 35 |
| Water | 0.4 | — |
| Fumed Alumina (untreated, 10-20 nm) | — | — |
| Reactive Resin | — | 4 |
| Resin Additives | — | 0.3 |

Trays were prepared used the method described in Example 1 and left exposed to air to accelerate the cure. The evolution in hardness after dispensing is provided in Table 6. For an organotin loading of 0.1 wt. %, the materials were uncured after 24 hours and did not reach a final hardness until 72 hours. In closed pucks, the materials did not cure within 7 days and showed cracks and mechanical flaws due to slow outgassing of the uncured material. Increasing the loading to 0.8 wt. % allowed the material to reach about 80% of its final cure within 24 hours, but further increases tended to reduce the hardness and cause non-uniformity within the material.

TABLE 6

| | Organotin | | | | | |
|---|---|---|---|---|---|---|
| | Catalyst | Storage Time (days) | | | | |
| ID | (wt. %) | 1 | 3 | 5 | 7 | 10 |
| B-1 | 0.1 | <5 | 40-45 | 50 | 50 | 50 |
| B-2 | 0.8 | 45 | 55-60 | 60 | 60 | 60 |
| B-3 | 1.2 | 45-50 | 45-50 | 50 | 50 | 50 |

The example highlights that the catalyst level can be increased to accelerate cure, but only by raising the loading to undesired levels. For most applications, the maximum amount of organotin that can be included is 0.1 wt. % of tin. This method is not preferred due to environmental and health hazards associated with tin-based catalysts.

### Example 3

Untreated fillers tend to have a more significant impact on viscosity and flow rate than treated fillers, which places a limitation on the maximum loading for many gap filling applications. It is desirable to use fillers with a large surface area to volume area to minimize the impact of filler addition on the dispense characteristics. For Example 3, a fumed alumina was selected to provide an extremely high surface area and thereby maximize the amount of alumina surface for a given volume fraction of filler.

TABLE 7

| | Part A | Part B |
|---|---|---|
| Component | (wt. %) | (wt. %) |
| Plasticizer | 8.1-8.2 | 4 |
| Rheology Modifier | 3.3-3.4 | 1 |
| Organotin Catalyst | 0.1 | — |
| Pigment | 0.2 | — |
| Alumina 1 | 56-59 | 55 |
| Alumina 2 | 29-32 | 35 |
| Water | 0.4 | — |
| Fumed Alumina (untreated, 10-20 nm) | 0.0-.05 | — |
| Reactive Resin | — | 4 |
| Resin Additives | — | 0.3 |

The materials were prepared using a planetary mixer and dispensed into open aluminum trays using a static mixer. The hardness after 24 hours measured using a Shore 00 durometer is listed in Table 8. For Example 3, a single Part B was used and different Part A's were prepared with fumed alumina loading varied from 0-0.5 wt. %.

TABLE 8

| | Fumed | | |
|---|---|---|---|
| | Alumina | Shore | |
| ID | wt. % | 00 | Change from Base |
| C-1 | 0.0 | 0 | Base formulation |
| C-2 | 0.2 | 15 | Replace fumed silica with fumed alumina |
| C-3 | 0.3 | 30 | Increase fumed alumina content to 0.3 wt. % |
| C-4 | 0.5 | 40 | Increase fumed alumina content to 0.5 wt. % |
| C-5 | 0.5 | 45 | Increase level of untreated coarse alumina |
| | | | from 56 to 57.5 wt. % |
| C-6 | 0.5 | 50 | Increase coarse alumina to 59 wt. % |

The base formulation without fumed alumina did not show a measurable hardness after 24 hours. The hardness increased with fumed alumina content up to Shore 00 of 40, which is 70% of the final hardness, at 0.5 wt. %. Increasing the amount of the larger diameter untreated alumina provided a further improvement in hardness (Example C-6), but at a much more limited rate with loading due to the significantly lower specific surface area.

### Example 4

The rate of increase in hardness was used as a proxy to evaluate the ability of different fillers to accelerate cure of the silane-modified resin. Example 4 includes the results of many experiments using different types of alumina as well as silica and zinc oxide, and for different types of surface treatment. The general parameter range of the mixed compositions in listed in Table 9

TABLE 9

| Component | Wt. % Range |
|---|---|
| Plasticizer | 5.7-7.2 |
| Rheology Modifier | 0.3-0.4 |
| Organotin Catalyst | 0.05 |
| Pigment | 0.07-0.10 |
| Alumina (course untreated, 20-80 μm) | 52-57 |
| Alumina (fine treated, 1-20 μm) | 10-36 |
| Alumina (fine untreated, 1-20 μm) | 0-25 |
| Alumina (sub-micron untreated) | 0-7 |
| Other Filler (sub-micron untreated) | 0-4 |
| Water | 0.1-0.2 |
| Reactive Resin | 2.0-2.6 |
| Resin Additives | 0.1-0.2 |

For Example 4, the main driver for cure rate of the dimethoxy-terminated polyether was the total amount of untreated surface area (USA) of a given filler (i) in the composition, such as alumina. This parameter was defined for each particle as USAᵢ=SSAᵢ*cᵢ, where SSAᵢ is the specific surface area in m²/g, of filler i, and cᵢ is the weight percentage in the composition. For compositions with multiple fillers, the total surface area of the fillers (TUSA) is defined as TUSA=Sum{USAᵢ*Aᵢ} where A is the activity index.

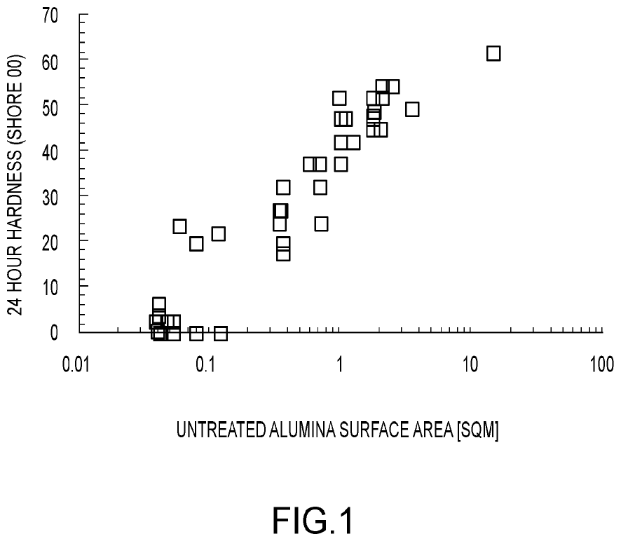

A summary of the Shore 00 hardness after 24 hours is provided in FIG. 1. The results show an extremely strong correlation between the amount of active surface area for untreated alumina and the hardness. The effect is more pronounced than changes in water content and catalyst loading, and similar effects were not observed with zinc oxide or silica.

The importance of the alumina surface is highlighted by the observation that the same grade of alumina did not show an enhanced cure rate after surface treatment with a silane group. Increasing the levels of compatibilizer or other dispersing aids designed to coat the surface of the alumina had a similar effect of reducing the cure rate by limiting the amount of exposed surface area and/or complexing with the organo-metal catalyst, thereby diminishing its activity.

A summary is provided of the activity index for different fillers. The activity index was obtained by optimizing a relationship between the total surface area of different fillers to the 24 hour hardness of trays as described in the above examples.

TABLE 10

| Name | Treatment | Diameter | SSA [m2/g] | Activity Index [A] |
|---|---|---|---|---|
| Alumina 1 | Untreated | 40-60 | 0.2 | 0.00 |
| Alumina 6 | Silane | 3-8 | 1.5 | 0.00 |
| Alumina 2 | Silane | 2-5 | 3.5 | 0.07 |
| Alumina 7 | Untreated | 2-5 | 3.5 | 0.66 |
| Alumina 8 | Silane | 3-6 | 1.9 | 0.08 |
| Alumina 9 | Untreated | 3-6 | 1.9 | 0.37 |
| Alumina 10 | Silane | 3-6 | 2.5 | 0.07 |
| Alumina 11 | Untreated | 3-6 | 2.5 | 0.33 |
| Alumina 5 | Untreated | 1-4 | 4.1 | 0.89 |
| Alumina 12 | Untreated | ~1 | 4 | 2.17 |
| Alumina 4 | Untreated | <1 | 8 | 4.04 |
| Alumina 3 | Untreated | <1 | 10 | 5.20 |
| Silica | Untreated | <1 | 10 | 0.00 |
| Zinc Oxide | Untreated | <1 | 10 | 0.00 |
| Fumed Silica | Untreated | <0.1 | 100 | 0.00 |
| Fumed | Untreated | <0.1 | 130 | 82.82 |

### Example 5

An additional composition Table 11 shows another slow curing composition which composes multiple types of thermally conductive fillers. The zinc oxide filler is untreated, but it is not sufficient to generate appreciable effect on curing acceleration. Even with 0.15 wt. % of organometallic catalysts, the composition cannot form a solid with measurable hardness. To clearly demonstrate the curing accelerating effect of high surface area alumina, a fumed alumina having an unmodified surface with at least 100 m²/g and an average particle size (d50) of less than 0.1 μm was added to the composition of Table 11 in different quantities, as shown in Table 12.

Table 12 shows the Shore 00 hardness of one-day and 4-day curing with different amount of fumed alumina. It shows the 1-day curing hardness increased almost linearly with loadings of fumed alumina.

TABLE 11

| Component | Wt. % Range |
|---|---|
| Plasticizer diluent | 15-17 |
| Rheology modifier | 0.1-0.2 |
| Graphite (untreated, D₅₀ of 20-30 μm) | 35-40 |
| Alumina (treated, D₅₀ of 1-3 μm) | 30-40 |
| Zinc oxide (untreated D₅₀ of 1-2 μm) | 2-2.5 |
| Water | 0.3-0.4 |
| Silyl modified resin and silane species | 5-7 |
| Resin additive (anti-oxidant, dispersant) | 0.3-0.4 |
| Organometallic catalyst | 0.15 |

TABLE 12

| | | Fumed alumina, unmodified, wt. % | | | |
|---|---|---|---|---|---|
| | | 0 | 0.35 | 0.7 | 1.05 |
| Hardness | cure time, 24 hr | 0 | 11 | 19 | 33 |
| (Shore 00) | cure time, 4 days | 20 | 41 | 55 | 66 |

1. A thermally conductive composition, comprising:
a condensation-curable silyl-modified resin; and
particulate alumina filler having a total specific surface area of at least 1 m²/g, wherein a portion of the particulate alumina filler has an average particle size of less than 1 μm, the portion comprising 0.1-10 wt. % of the composition;
less than 0.1 wt. % organo-metal catalyst; and
less than 0.5 wt. % water,
wherein the composition exhibits a thermal conductivity of at least 1 W/m*K.

2. The thermally conductive composition of claim 1, wherein the particulate alumina is unmodified.

3. The thermally conductive composition of claim 1, wherein at least the portion of the particulate alumina filler includes fumed alumina.

4. The thermally conductive composition of claim 1, wherein the alumina filler includes at least one of alpha and gamma crystal structure.

5. The thermally conductive composition of claim 1, wherein the total specific surface area is between 4 m²/g and 150 m²/g.

6. The thermally conductive composition of claim 1, comprising:
between 1 wt. % and 7 wt. % of the silyl-modified resin; and
between 50 wt. % and 95 wt. % of the particulate alumina filler.

7. The thermally conductive composition of claim 1, comprising between 0.1 wt. % and 1 wt. % of the portion of the particulate alumina filler having an average particle size of less than 1 μm.

8. The thermally conductive composition of claim 1, comprising between 5 wt. % and 20 wt. % of a plasticizer having a viscosity of less than 100 cP at 25° C.

9. The thermally conductive composition of claim 1, wherein:
the silyl-modified resin is a silane-terminated polyether; and/or
the silyl-modified non-silicone polymer includes an alkoxy silane terminal group; and/or
the silyl-modified non-silicone polymer is free of —Si—O— units; and/or
the silyl-modified non-silicone polymer is a two part composition.

10. The thermally conductive composition of claim 1, wherein each component has an extrusion rate of greater than 50 g/minute, preferably greater than 150 g/minute and more preferably greater than 300 g/minute when extruded through a Nordson EFD syringe barrel at 90 psi.

11. Cured reaction products of the thermally conductive composition of claim any one of claim 1.

12. Cured reaction products of the thermally conductive composition of claim 1, having a cured hardness of between 20 Shore 00 and 80 Shore A at 25° C.

13. A battery system, comprising:
a battery; and
the thermally conductive composition of claim 1 thermally coupled to the battery.

14. A thermal interface material, comprising:
1-7 wt. % of a condensation-curable silyl-modified resin; and
50-95 wt. % of thermally conductive particulate filler having a particle size distribution, with a first portion of the thermally conductive filler being alumina and comprising between 0.1 wt. % and 10 wt. % of the thermal interface material, and having an average particle size of between 5 nm and 1000 nm and a specific surface area of between 4 m²/g and 150 m²/g,
wherein the thermal interface material exhibits a thermal conductivity of at least 1 W/m*K, and a cured hardness of between 20 Shore 00 and 80 Shore A at 25 ºC.

15. The thermal interface material of claim 14, wherein:
the particulate alumina filler has a total specific surface area of at least 1 m²/g; and/or
the first portion of the thermally conductive filler has an average particle size of between 5 nm and 250 nm; and/or
the particulate alumina filler is unmodified.

16. A two-part curable composition, comprising:
a first part including thermally conductive filler having a particle size distribution, with a first portion of the thermally conductive filler being alumina and comprising between 0.1 wt. % and 10 wt. % of the first part and having an average particle size of between 5 nm and 1000 nm and a specific surface area of between 4 m²/g and 150 m²/g, and a second portion of the thermally conductive filler comprising between 80 wt. % and 95 wt. % of the first part and having an average particle size of between 1 μm and 100 μm; and
a second part including a condensation-curable silyl-modified resin, wherein the resin is curable with exposure to the first part to a gel condition having a hardness of between 20 Shore 00 and 80 Shore A at 25° C.

17. The two-part curable composition of claim 16 wherein:
the silyl-modified resin is a silane-terminated polyether; and/or
the silyl-modified non-silicone polymer includes an alkoxy silane terminal group; and/or
the silyl-modified non-silicone polymer is free of —Si—O— units.

18. The two-part curable composition of claim 16, wherein the first part includes less than 0.5 wt. % organo-metal catalyst and less than 0.5 wt. % water.

19. The two-part curable composition of claim 16, wherein the second part includes between 80 wt. % and 95 wt. % thermally conductive filler selected from alumina, aluminum trihydrate, aluminum nitride, aluminum hydroxide, graphite, zinc oxide, magnesium oxide, silicon carbide, boron nitride, metal particles, and combinations thereof.

20. The two-part curable composition of claim 16, wherein the cured material exhibits a thermal conductivity of at least 1 W/m*K.

21. The two-part curable composition of claim 16, wherein the cured material includes particulate alumina having a total specific surface area of at least 1 m²/g.

22. (canceled)
